(19) United States
(12) Patent Application Publication
(10) Pub. No.: US 2026/0137584 A1
(43) Pub. Date: May 21, 2026

(54) GUIDE ROD-DRIVEN MASSAGER

(71) Applicant: Dongguan Duoguo Zhichuang Technology Co., Ltd., Dongguan City (CN)

(72) Inventor: Changzhi Luo, Dongguan City (CN)

(21) Appl. No.: 19/421,970

(22) Filed: Dec. 16, 2025

(30) Foreign Application Priority Data
Nov. 18, 2025 (CN) 202511691955.0

(51) Int. Cl. A61H 15/00; A61H 23/02

(52) U.S. Cl. CPC A61H 15/0078; A61H 23/02; A61H 2015/0014; A61H 2201/0153; A61H 2201/0207; A61H 2201/10; A61H 2201/1215; A61H 2201/123; A61H 2201/149; A61H 2201/5069; A61H 2201/5092

(57) ABSTRACT

A guide rod-driven massager, including a shell base, a guide base disposed on the shell base and provided with a guide perforation thereon, a guide rod fitted through the guide perforation, a power apparatus configured to drive the guide rod to move reciprocally, and a massage roller disposed on the guide rod to move with the guide rod. Accordingly, the guide rod-driven massager for ensuring smooth guided sliding by assembling the massage roller and the guide rod is provided.

### TECHNICAL FIELD

The present disclosure belongs to the field of massagers, and particularly relates to a guide rod-driven massager.

### BACKGROUND

A sleeve-type massager is one of common massagers, which is used to massage fingers, palms, toes and feet by means of a reciprocating motion of a massage roller after being sleeved on the fingers, the palms, the toes and the feet.

An existing sleeve-type massager is of a design in which a base is disposed at a bottom of the massage roller, a guide rail extending in a front-rear direction is disposed on the base, and a sliding block is disposed on the bottom of the massage roller, such that the massage roller reciprocates by means of a cooperation of the sliding block and the guide rail.

However, it has been found during the use that if small particles such as stones fall into the guide rail, the smoothness of the sliding block sliding within the guide rail is influenced, or even the guide rail and the sliding block are damaged, resulting in a sliding failure.

### SUMMARY

In view of shortcomings of the prior art, an objective of the present disclosure is to provide a guide rod-driven massager ensuring smooth guided sliding by assembling a massage roller and a guide rod.

In order to achieve the above objective, the present disclosure provides the following technical solution. The guide rod-driven massager includes a shell base, a guide base disposed on the shell base and provided with a guide perforation extending in a first direction thereon, a guide rod fitted through the guide perforation, a power apparatus configured to drive the guide rod to move reciprocally in the first direction, and a massage roller disposed on the guide rod to move with the guide rod.

Further, the power apparatus and the massage roller are disposed at two ends of the guide perforation; and/or an assembly chamber is disposed within the shell base, the power apparatus is disposed within the assembly chamber, the massage roller is disposed outside the assembly chamber, an outwardly-extending perforation is provided in the shell base, and the guide rod is fitted through the outwardly-extending perforation to make a portion of the guide rod be positioned within the assembly chamber and a portion of the guide rod be positioned outside the assembly chamber.

Further, the power apparatus includes a power component, a power screw rod and a sliding base, wherein the power screw rod is rotatably disposed on the shell base, the sliding base is disposed on the guide rod, the sliding base is in screw-thread fit with the power screw rod, and the power component is configured to drive the power screw rod to rotate; and the power screw rod rotates to drive the sliding base to move in the first direction.

Further, the power component includes a power motor and a sensor, wherein the power motor is configured to drive the power screw rod to rotate, and the sensor is configured to detect a rotation angle of an output shaft of the power motor.

Further, the sensor is a photoelectric sensor, a Hall sensor or an encoder.

Further, the massage roller is provided with a massage chamber penetrating in the first direction, the massage chamber is provided with an insertion opening at one end thereof and a protrusion opening at the other end thereof, and the shell base is provided with an end abutment portion at the protrusion opening.

Further, the end abutment portion is made of an elastic material.

Further, a first functional element operating upon being electrified is disposed on the end abutment portion.

Further, the first functional element is at least one of a heating element, an electric shock element and a vibration element.

Further, the guide rod is provided in a quantity of two, and made of a conductive material; and a second functional element operating upon being electrified is disposed on the massage roller.

Further, a second circuit board is disposed on the shell base, and an elastic abutment element is disposed on the second circuit board corresponding to the individual guide rods respectively.

Further, an installation insertion hole, a threaded hole and a wire opening are disposed on the massage roller corresponding to the individual guide rods respectively, one end of each of the guide rods is provided with a first perforation, the guide rod is inserted into the installation insertion hole; and the massager further includes an installation bolt fitted through the first perforation and screwed to the threaded hole, the second functional element is provided with a conducting wire corresponding to the individual guide rods respectively, and the conducting wire extends into the installation insertion hole through the wire opening and is in conduction with the guide rod.

Further, the second functional element is at least one of a heating element, an electric shock element and a vibration element.

By adopting the above technical solution, 1, a site needing to be massaged may be inserted into the massage roller; under an operation of the power apparatus, the guide rod moves reciprocally in a left-right direction relative to the shell base, thereby driving the massage roller to synchronously move reciprocally in the left-right direction to massage the site needing to be massaged; and 2, since a sliding guided fit is performed between the guide rod and the guide base in an inserting and sleeving manner, small particles are less likely to adhere to both the guide rod and the guide base, ensuring the smoothness of the sliding fit between the guide rod and the guide base.

### BRIEF DESCRIPTION OF THE DRAWINGS

FIG. 1 is an assembly view of a specific embodiment of the present disclosure;

FIG. 2 is an exploded view of a specific embodiment of the present disclosure;

FIG. 3 is an exploded view of a shell base in a specific embodiment of the present disclosure;

FIG. 4 is an assembly view of a power apparatus in a specific embodiment of the present disclosure;

FIG. 5 is an assembly view of a power apparatus in a specific embodiment of the present disclosure;

FIG. 6 is an enlarged view of A in FIG. 4;

FIG. 7 is an exploded view of a massage roller in a specific embodiment of the present disclosure;

FIG. 8 is a cross-sectional view of a massage roller in a specific embodiment of the present disclosure; and

FIG. 9 is an enlarged view of B in FIG. 8.

### DESCRIPTION OF REFERENCE SYMBOLS

1, shell base; 11, assembly chamber; 12, outwardly-extending perforation; 13, end abutment portion; 14, handle component; 15, clamping slot; 16, clamping sheet; 17, sealing ring; 141, holding portion; 142; liquid receiving tray; 2, guide base; 21, guide perforation; 3, guide rod; 31, first perforation; 4, power apparatus; 41, power component; 42, power screw rod; 43; sliding base; 44; sensor; 411, power motor; 412, driving gear; 413; driven gear; 5, battery; 6, first circuit board; 7, massage roller; 71; massage chamber; 72, lower protrusion; 73, installation bolt; 74, conducting wire; 75, hard outer shell; 76; soft inner sleeve; 711; massage protrusion; 712, insertion opening; 713, protrusion opening; 721, installation insertion hole; 722, threaded hole; 723, wire opening; 8, installation shell; 91, first functional element; 92, second functional element; 10, second circuit board; and 101, elastic abutment element.

### DESCRIPTION OF THE EMBODIMENTS

### Embodiment 1

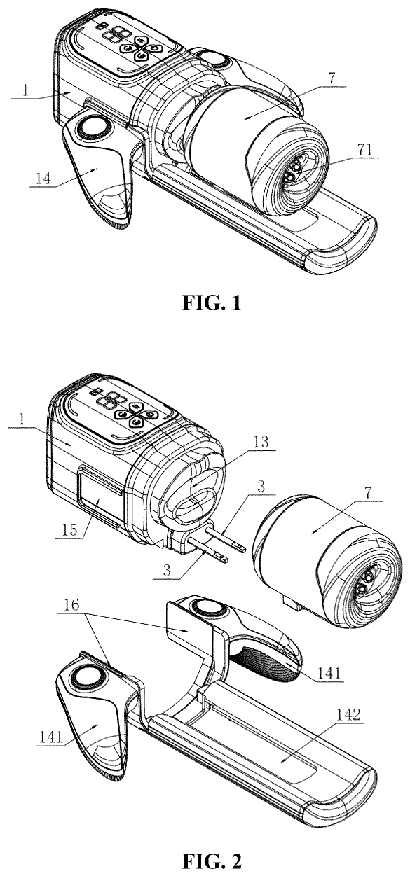

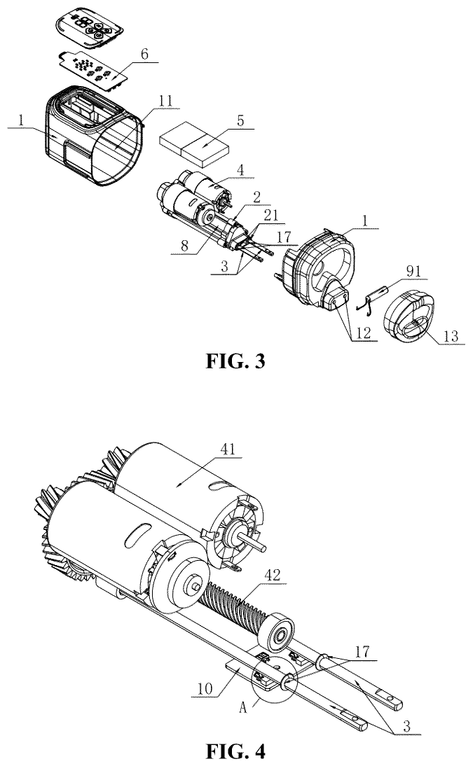

As shown in FIG. 1 to FIG. 3, the present disclosure discloses a guide rod-driven massager, including a shell base 1, a guide base 2, a guide rod 3, a power apparatus 4, a battery 5, a first circuit board 6 and a massage roller 7.

An assembly chamber 11 is disposed within the shell base 1, and an outwardly-extending perforation 12 is provided at a lower position on a right side of the shell base 1 to communicate the assembly chamber 11 with an outside of the shell base 1. The guide base 2 is disposed within the assembly chamber 11, and fixedly arranged relative to the shell base 1. A guide perforation 21 extending in a left-right direction is provided in the guide base 2. The guide rod 3 is fitted through the outwardly-extending perforation 12, such that a portion of the guide rod 3 at a left end of the outwardly-extending perforation 12 is located within the assembly chamber 11 and a portion of the guide rod 3 at a right end of the outwardly-extending perforation 12 extends out of the shell base 1. In addition, the guide rod 3 is stably slidably fitted to the shell base 1 by fitting a guide perforation 21 through the assembly chamber 11. The power apparatus 4 is disposed within the assembly chamber 11, and configured to drive the guide rod 3 reciprocally in the left-right direction. The battery 5 supplies power to a circuit system. The first circuit board 6 is configured to control an operation of the power apparatus 4. The massage roller 7 is located on the right side of the shell base 1, that is, the massage roller 7 is located outside the assembly chamber 11. The massage roller 7 and the guide rod 3 are fixedly arranged such that a movement of the guide rod 3 may synchronously drive the massage roller 7 to move.

A site needing to be massaged may be inserted into the massage roller of the massager with the above structure. Under an operation of the power apparatus 4, the guide rod 3 moves reciprocally in the left-right direction relative to the shell base 1, thereby driving the massage roller 7 to synchronously move reciprocally in the left-right direction to massage the site needing to be massaged.

Further, since a sliding guided fit is performed between the guide rod 3 and the guide base 2 in an inserting and sleeving manner, small particles are less likely to adhere to both the guide rod 3 and the guide base 2, ensuring the smoothness of the sliding fit between the guide rod 3 and the guide base 2.

The power apparatus 4 and the massage roller 7 are disposed at two ends of the guide perforation 21 to make the whole more stable.

An installation shell 8 is disposed within the assembly chamber 11 within the shell base 1, the guide base 2 is disposed at a right portion of the installation shell 8, and the power apparatus 4 is assembled on the installation shell 8.

A sealing ring 17 is clamped between the guide base 2 and the shell base 1, and installed around a periphery of the guide rod 3 to performing the sealing at the outwardly-extending perforation 12.

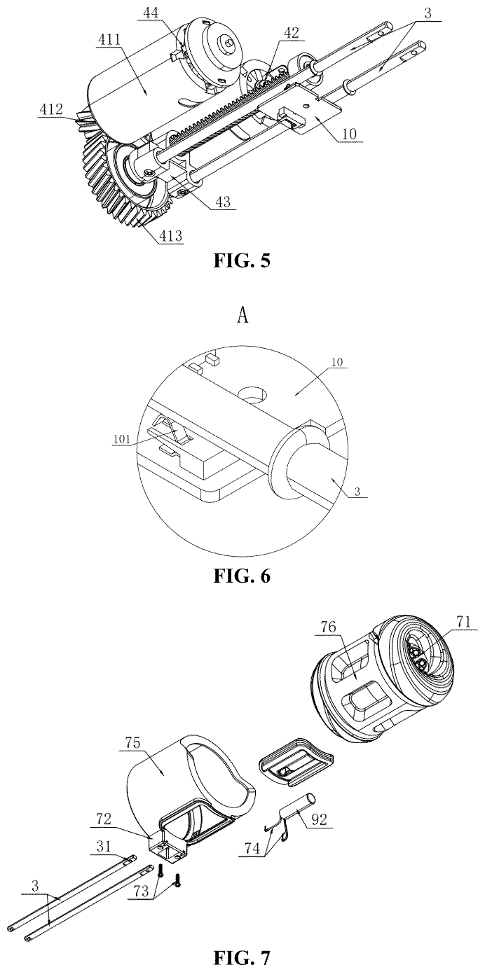

Particularly, as shown in FIG. 4 to FIG. 6, the power apparatus 4 includes a power component 41, a power screw rod 42 and a sliding base 43. A length direction of the power screw rod 42 is in the left-right direction, and bearings are disposed at left and right ends of the power screw rod 42, respectively, such that the power screw rod 42 is rotatably installed inside the installation shell 8 by means of the bearings. The sliding base 43 is fixedly installed on a left end of the guide rod 3 by adopting a bolt, is installed around a periphery of the power screw rod 42, and is in screw-thread fit with the power screw rod 42. The power component 41 is configured to drive the power screw rod 42 to rotate.

Therefore, the power component 41 operates to drive the power screw rod 42 to rotate, and the power screw rod 42 is in screw-thread fit with the sliding base 43 to achieve a synchronous movement of the sliding base 43, the guide rod 3 and the massage roller 7 in the left-right direction, in order to provide a massage effect.

Furthermore, the power component 41 includes a power motor 411, a driving gear 412 and a driven gear 413. The power motor 411 is disposed on an outer side above the installation shell 8, and an output shaft of the power motor 411 leftwards extends into the installation shell 8. The driving gear 412 is fixedly disposed on the output shaft of the power motor 411, and the driven gear 413 is fixedly disposed on a left end of the power screw rod 42. Moreover, the driving gear 412 and the driven gear 413 are arranged in an engagement manner.

The power motor 411 operates to drive the driving gear 412 to rotate, such that the power screw rod 42 rotates for output under the engagement of the driving gear 412 and the driven gear 413. Moreover, the power motor 411 is located outside the installation shell 8 to improve the heat dissipating effect of the power motor 411. The driving gear 412, the driven gear 413, the power screw rod 42 and the sliding base 43 are located inside the installation shell 8 to prevent the movement from being interfered and ensure the stability of the movement.

It should be noted that this embodiment achieves that the power screw rod 42 drives the sliding base 43 to leftwards or rightwards move by means of forward and reverse rotations of the power motor 411.

Preferably, both the power motor 411 and the driving gear 412 are provided in plural, and provided in a quantity of two in this embodiment. Each of the power motors 411 is connected to a different one of the driving gears 412, and each of the driving gears 412 is engaged with the driven gear 413 to increase kinetic energy by means of a plurality of power motors 411.

Preferably, the modulus of the driving gear 412 is smaller than that of the driven gear 413, such that the driving gear 412 and the driven gear 413 are in deceleration fit while reducing a movement speed of the massage roller 7.

In addition, the power component 41 further includes a sensor 44 for detecting a rotation angle of an output shaft of the power motor 411. By detecting the rotation of the power motor 411 by means of the sensor 44, the position of the massage roller 7 may be determined, and thus a motion stroke of the massage roller 7 may be controlled by means of programming.

Particularly, the sensor 44 is a photoelectric sensor, a Hall sensor or an encoder.

Particularly, the output shaft of the power motor 411 leftwards extends, and the sensor 44 is installed at a right end of the power motor 411 to detect a portion of the output shaft of the power motor 411 leftwards extending.

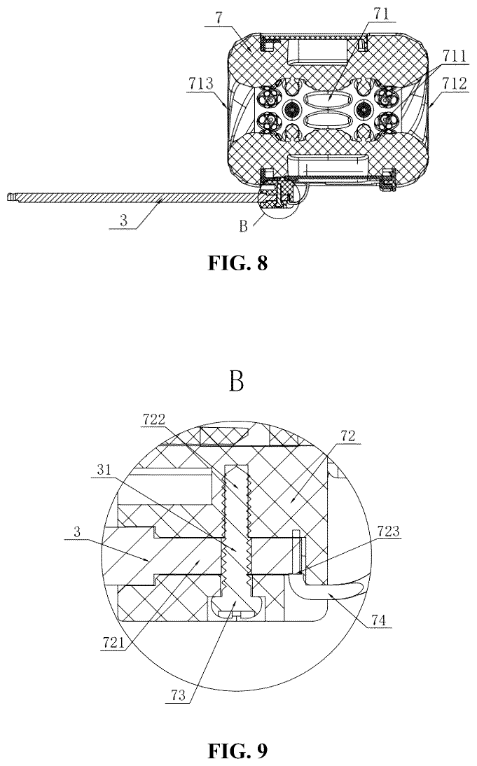

As shown in FIG. 7 to FIG. 9, the massage roller 7 includes a hard outer shell 75 and a soft inner sleeve 76. The soft inner sleeve 76 is clamped inside the hard outer shell 75. The soft inner sleeve 76 is provided with a massage chamber 71 running through in the left-right direction. A plurality of massage protrusions 711 are orderly arranged inside the massage chamber 71. The massage chamber 71 is provided with an insertion opening 712 at a right end thereof and a protrusion opening 713 at a left end thereof. In addition, the shell base 1 is provided with an end abutment portion 13 at the protrusion opening 713. The soft inner sleeve 76 is made of a silicone material.

Therefore, the site needing to be massaged extends from the insertion opening 712 into the massage chamber 71, extends out of the protrusion opening 713, and abuts against the end abutment portion 13 to complete an insertion action.

Preferably, the end abutment portion 13 is made of an elastic material, making an abutment action more comfortable.

In addition, a first functional element 91 operating upon being electrified is disposed on the end abutment portion 13. Particularly, the first functional element 91 is at least one of a heating element (such as a heating sheet), an electric shock element (such as an electric shock sheet) and a vibration element (such as a vibration motor).

Accordingly, the massage effect may be optimized by enabling heating, electric shock, vibration and other functions.

Preferably, the guide rod 3 in this embodiment is provided in a quantity of two, in order to improve the movement stability of the massage roller 7 by the two guide rods 3.

The guide rod 3 is made of a conductive material. In addition, a second functional element 92 operating upon being electrified is disposed on the massage roller 7, such that by connecting the two guide rods 3 to positive and negative poles respectively on the shell base 1, the guide rod 3 may supply power to the second functional element 92 on the relatively stationary massage roller 7 to achieve the operation of the second functional element 92.

In addition, the installation shell 8 in this embodiment is provided with a second circuit board 10 and a first circuit board 6 electrically connected below a left side of the guide base 2. Elastic abutment elements 101 are disposed above the second circuit board 10 corresponding to the individual guide rods 3 respectively.

Therefore, by making the elastic abutment elements 101 abut against the guide rod 3, a continuous and stable conduction loop is achieved for the guide rod 3 needing to move in the left-right direction.

In further embodiments, no elastic abutment element 101 may be disposed on the second circuit board 10. However, a conductive wire is used to electrically connect the second circuit board 10 and the guide rod 3 to achieve the power supply.

Particularly, a lower protrusion 72 is disposed on a left side of a bottom of the hard outer shell 75. The lower protrusion 72 is provided with an installation insertion hole 721, a threaded hole 722 and a wire opening 723 corresponding to the individual guide rods 3 respectively, wherein the installation insertion hole 721 extends in the left-right direction, and a left end of the installation insertion hole 721 runs through the lower protrusion 72; and the threaded hole 722 extends upwards, and a lower end of the threaded hole 722 runs through the lower protrusion 72. The threaded hole 722 and the installation insertion hole 721 intersect in a cross shape. The wire opening is provided below a right end of the installation insertion hole 721. In addition, each of the guide rod 3 is provided with a first perforation 31 running through in an up-down direction at a right end thereof.

Furthermore, the guide rod 3 is rightwards fitted through the installation insertion hole 721. In addition, the massager further includes an installation bolt 73 upwards fitted through the first perforation 31 and threaded to the threaded hole 722, so as to fixedly install the guide rod 3 and the massage roller 7.

Furthermore, the second functional element 92 is provided with a conducting wire 74 corresponding to the individual guide rods 3 respectively. The conducting wire 74 is of a structure such as an electric wire, extends into the installation insertion holes 721 through the wire opening 723, and is clamped by right walls of the guide rod 3 and the installation insertion hole 721 to achieve the conduction between the conducting wires 74 and the guide rod 3, ensuring the power supply stability of the second functional element 92.

Particularly, a second functional element 92 is at least one of a heating element (such as a heating sheet), an electric shock element (such as an electric shock sheet) and a vibration element (such as a vibration motor).

Accordingly, the massage effect may be optimized by enabling heating, electric shock, vibration and other functions.

In addition, a handle component 14 is detachably disposed on the shell base 1, wherein the handle component 14 is provided with a holding portion 141 on a front side and a rear side of the shell base 1, respectively, such that the holding component may be held with both hands for use.

In addition, the handle component 14 is provided with a liquid receiving tray 142 below the massage roller 7, such that the massage effect may be improved by applying a cleansing lotion, a moisturizing lotion and the like to the site needing to be massaged. The lotion may be collected by the liquid receiving tray 142, thereby guaranteeing the hygienic use.

The shell base 1 is provided with a clamping slot 15 in a front side and a rear side thereof, and the handle component 14 is provided with a clamping sheet 16 on one side opposite to each of the holding portions 141, such that the shell base 1 and the handle component 14 are detachably installed by means of the clamping slots 15 and the clamping sheets 16.

In addition, the liquid receiving tray 142 is provided with an elastic element on a right side thereof to make the contact with a human body more comfortable.

This embodiment defines the left-right direction as the first direction.

### Embodiment 2

The present disclosure discloses a guide rod-driven massager which has the same main structure as the embodiment 1, except that the guide rods 3 is provided in singular, making the overall structure simpler.

### Embodiment 3

The present disclosure discloses a guide rod-driven massager which has the same main structure as the embodiment 1 or the embodiment 2, except that both the power motor 411 and the driving gear 412 are provided in singular, resulting in lower production cost.

What is claimed is:

1. A guide rod-driven massager, comprising:
a shell base;
a guide base disposed on the shell base and provided with a guide perforation extending in a first direction thereon;
a guide rod fitted through the guide perforation;
a power apparatus configured to drive the guide rod to move reciprocally in the first direction; and
a massage roller disposed on the guide rod to move with the guide rod.

2. The guide rod-driven massager according to claim 1, wherein the power apparatus and the massage roller are disposed on two ends of the guide perforation; and/or an assembly chamber is disposed within the shell base, the power apparatus is disposed within the assembly chamber, the massage roller is disposed outside the assembly chamber, an outwardly-extending perforation is provided in the shell base, and the guide rod is fit through the outwardly-extending perforation to make a portion of the guide rod be positioned within the assembly chamber and a portion of the guide rod be positioned outside the assembly chamber.

3. The guide rod-driven massager according to claim 1, wherein the power apparatus comprises a power component, a power screw rod and a sliding base, wherein the power screw rod is rotatably disposed on the shell base, the sliding base is disposed on the guide rod, the sliding base is in screw-thread fit with the power screw rod, and the power component is configured to drive the power screw rod to rotate; and
the power screw rod rotates to drive the sliding base to move in the first direction.

4. The guide rod-driven massager according to claim 3, wherein the power component comprises a power motor, a driving gear and a driven gear, the power motor is disposed on the shell base, the driving gear is disposed on an output shaft of the power motor, the driven gear is disposed on the power screw rod, and the driving gears and the driven gear are arranged in an engagement manner.

5. The guide rod-driven massager according to claim 4, wherein both the power motor and the driving gear are provided in plural, each of the power motors is connected to a different one of the driving gears, and the individual driving gears are engaged with the driven gear, respectively.

6. The guide rod-driven massager according to claim 3, wherein the power component comprises a power motor and a sensor, the power motor is configured to drive the power screw rod to rotate, and the sensor is configured to detect a rotation angle of the output shaft of the power motor.

7. The guide rod-driven massager according to claim 6, wherein the sensor is a photoelectric sensor, a Hall sensor or an encoder.

8. The guide rod-driven massager according to claim 1, wherein the massage roller is provided with a massage chamber penetrating in the first direction, the massage chamber is provided with an insertion opening at one end thereof and a protrusion opening at the other end thereof, and the shell base is provided with an end abutment portion at the protrusion opening.

9. The guide rod-driven massager according to claim 8, wherein the end abutment portion is made of an elastic material.

10. The guide rod-driven massager according to claim 8, wherein a first functional element operating upon being electrified is disposed on the end abutment portion.

11. The guide rod-driven massager according to claim 10, wherein the first functional element is at least one of a heating element, an electric shock element and a vibration element.

12. The guide rod-driven massager according to claim 1, wherein the guide rod is provided in singular.

13. The guide rod-driven massager according to claim 1, wherein the guide rod is provided in a quantity of two, and the guide rod is made of a conductive material; and
a second functional element operating upon being electrified is disposed on the massage roller.

14. The guide rod-driven massager according to claim 13, wherein a second circuit board is disposed on the shell base, and an elastic abutment element is disposed on the second circuit board corresponding to the individual guide rods respectively.

15. The guide rod-driven massager according to claim 13, wherein a second circuit board is disposed on the shell base, and a conductive wire is disposed between the second circuit board and each of the guide rods.

16. The guide rod-driven massager according to claim 13, wherein an installation insertion hole, a threaded hole and a wire opening are respectively disposed on the massage roller corresponding to the individual guide rods respectively, one end of each of the guide rods is provided with a first perforation, the guide rod is inserted into the installation insertion hole; and the massager further comprises an installation bolt fitted through the first perforation and screwed to the threaded hole, the second functional element is provided with a conducting wire corresponding to the individual guide rods respectively, and the conducting extends into the installation insertion hole through the wire opening and is in conduction with to the guide rod.

17. The guide rod-driven massager according to claim 13, wherein the second functional element is at least one of a heating element, an electric shock element and a vibration element.

18. The guide rod-driven massager according to claim 1, wherein a handle component is disposed on the shell base, and holding portions are respectively disposed on two sides of the shell base;
the handle component has a liquid receiving tray below the massage roller; and
clamping slots are disposed on two sides of the shell base, the handle component is provided with a clamping sheet on one side opposite to each of the holding portions, and the clamping slots and the clamping sheets are matched to achieve detachable installation of the shell base and the handle component.
